(19) United States
(12) Patent Application Publication
(10) Pub. No.: US 2025/0225196 A1
(43) Pub. Date: Jul. 10, 2025

(54) CLASSICAL-QUANTUM HYBRID ALGORITHM FOR SOLVING HIGHER-ORDER MIXED INTEGER PROGRAMMING PROBLEMS

(71) Applicant: International Business Machines Corporation, Armonk, NY (US)

(72) Inventor: Mitsuharu Takeori, Chiba (JP)

(21) Appl. No.: 18/405,069

(22) Filed: Jan. 5, 2024

(51) Int. Cl. G06F 17/11

(52) U.S. Cl. CPC G06F 17/11

(57) ABSTRACT

One or more systems, devices, computer program products and/or computer-implemented methods of use provided herein relate to a classical-quantum hybrid algorithm for solving higher-order mixed integer programming MIP problems. A system can comprise a memory that can store computer-executable components. The system can further comprise a processor that can execute the computer-executable components stored in the memory, wherein the computer-executable components can comprise a classical computation component that can employ a quantum-classical hybrid algorithm to update one or more continuous variables in a higher-order MIP problem using classical optimization. The computer-executable components can further comprise a quantum computation component that can employ the quantum-classical hybrid algorithm to update one or more binary variables in the higher-order MIP problem using quantum optimization.

### BACKGROUND

The subject disclosure relates to quantum computing, and more specifically to a classical-quantum hybrid algorithm for solving higher-order mixed integer programming (MIP) problems.

Quantum computing is generally the use of quantum-mechanical phenomena for the purpose of performing computing and information processing functions. Quantum computing can be viewed in contrast to classical computing, which generally operates on binary values with transistors. That is, while classical computers can operate on bit values that are either 0 or 1, quantum computers operate on quantum bits that comprise superpositions of both 0 and 1, can entangle multiple quantum bits, and use interference. The use of quantum computers can be seen as a promising approach for combinatorial problems. However, such problems are often challenging to solve using only quadratic unconstrained binary optimization (QUBO) when such problems involve higher-order terms, many continuous variables, and many constraints. In addition, formulating a higher-order constraint problem as a QUBO involves the introduction of many slack variables, which can become an infeasible problem on existing quantum devices with a limited number of qubits.

The above-described background description is merely intended to provide a contextual overview regarding quantum computing and combinatorial problems and is not intended to be exhaustive.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable a classical-quantum hybrid algorithm for solving higher-order MIP problems are discussed.

According to an embodiment, a system is provided. The system can comprise a memory that can store computer-executable components. The system can further comprise a processor that can execute the computer-executable components stored in the memory, where the computer-executable components can comprise a classical computation component that can employ a quantum-classical hybrid algorithm to update one or more continuous variables in a higher-order MIP problem using classical optimization. The computer-executable components can further comprise a quantum computation component that can employ the quantum-classical hybrid algorithm to update one or more binary variables in the higher-order MIP problem using quantum optimization. Such embodiments of the system can provide a number of advantages, including solving a higher-order unconstrained binary optimization (HUBO) directly, without needing to deduct the HUBO to a QUBO, with efficient resource utilization in terms of the number of qubits needed to solve the HUBO.

In one or more embodiments of the aforementioned system, the classical computation component can update the one or more continuous variables on a classical system by fixing the one or more binary variables. In one or more embodiments of the aforementioned system, the quantum computation component can update the one or more binary variables on a quantum system by fixing the one or more continuous variables. In one or more embodiments of the aforementioned system, a formulation component can formulate the higher-order MIP problem for applying an augmented Lagrange scheme. In one or more embodiments of the aforementioned system, a precomputation component can select a solution of a relaxation problem as an initial value used by the quantum-classical hybrid algorithm to solve the higher-order MIP problem. In one or more embodiments of the aforementioned system, the precomputation component can select a result generated by applying a computationally cheap cut or lifting to a relaxed problem as the initial value. In one or more embodiments of the aforementioned system, employing the quantum-classical hybrid algorithm can separate the higher-order MIP problem into a continuous optimization problem and a binary optimization problem. In one or more embodiments of the aforementioned system, a size of the binary optimization problem can remain equal to a number of one or more binary variables in the higher-order MIP problem. In one or more embodiments of the aforementioned system, the binary optimization problem can be solved using quantum algorithms and without introducing auxiliary binary variables. Such embodiments of the system can provide a number of advantages, including solving a HUBO directly, without needing to deduct the HUBO to a QUBO, preventing a size of the binary optimization problem from increasing due to higher-order terms and constraints, and reducing resource utilization during a quantum computing process.

According to various embodiments, the above-described system can be implemented as a computer-implemented method or as a computer program product.

### BRIEF DESCRIPTION OF THE DRAWINGS

One or more embodiments are described below in the Detailed Description section with reference to the following drawings:

FIG. 1 illustrates a block diagram of an example, non-limiting system that can employ a classical-quantum hybrid algorithm for solving higher-order MIP problems in accordance with one or more embodiments described herein.

FIG. 2 illustrates diagrams of example, non-limiting updates comprised in the classical-quantum hybrid algorithm for solving higher-order MIP problems in accordance with one or more embodiments described herein.

FIG. 3 illustrates example, non-limiting graphs showing optimization results generated for target problems by employing the classical-quantum hybrid algorithm in accordance with one or more embodiments described herein.

FIG. 4 illustrates example, non-limiting graphs showing optimization results generated for a knapsack problem and multiple knapsack problems by employing the classical-quantum hybrid algorithm in accordance with one or more embodiments described herein.

FIG. 5 illustrates example, non-limiting graphs showing optimization results generated for a job-shop scheduling problem by employing the classical-quantum hybrid algorithm in accordance with one or more embodiments described herein.

FIG. 6 illustrates example, non-limiting graphs showing optimization results generated for a travel salesman problem by employing the classical-quantum hybrid algorithm in accordance with one or more embodiments described herein.

FIG. 7 illustrates example, non-limiting graphs showing optimization results generated for an arbitrage opportunity optimization problem by employing the classical-quantum hybrid algorithm in accordance with one or more embodiments described herein.

FIG. 8 illustrates an example, non-limiting graph and an example, non-limiting chart showing optimization results generated for structure learning of a Bayesian network by employing the classical-quantum hybrid algorithm in accordance with one or more embodiments described herein.

FIG. 9 illustrates a flow diagram of an example, non-limiting method that can employ a classical-quantum hybrid algorithm for solving higher-order MIP problems in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Many practical problems in the real world are not pure binary problems, and instead, can be formulated as constrained MIPs. Although the use of quantum computers can be seen as a promising approach for solving combinatorial problems, such problems are often challenging to solve using only QUBO when such problems involve higher-order terms, many continuous variables, and many constraints. In addition, formulating a higher-order constraint problem as a QUBO involves the introduction of many slack variables, which can become an infeasible problem on existing quantum devices with a limited number of qubits. Existing quantum approaches usually address problems with only quadratic degrees of polynomials (i.e., only second order polynomials). Further, many quantum approaches, such as quantum annealing, can only solve binary problems having only binary variables. Standard quantum approaches need to deduct higher-order MIP problems to quadratic binary problems for solving the higher-order MIPs. For example, some existing techniques need to deduct a HUBO of size N to a QUBO of size M>N to solve a higher-order MIP using various techniques (e.g., inspired quantum approaches, classical QUBO solvers, quantum annealing or gate-based approaches), whereas another existing technique needs to deduct a HUBO of size N to a linear programming (LP) problem of size N+O (n_{terms of degrees≥2}) with linear constraints O (n_{terms of degrees≥2}²) before applying commercial solvers (e.g., CPLEX, Gurobi (branch and bound)). Thus, an effective quantum algorithm to solve higher-order MIPs directly and efficiently using existing quantum computers can be desirable.

Various embodiments of the present disclosure can be implemented to produce a solution to one or more of the above discussed problems. Embodiments described herein include systems, computer-implemented methods, and computer program products that can establish a valid framework that can mitigate challenges associated with higher-order terms, many continuous variables, and many constraints in a problem, and solve an MIP problem using an algorithm that can be implemented on existing quantum computers. The optimization framework disclosed in various embodiments herein for solving a target problem can consist of three parts, namely, a formulation, an algorithm, and a choice of initial values. For example, in various embodiments, a formulation can first be established for a target problem. The formulation can be a higher-order MIP formulation representing the target problem, and the formulation can be generated on a classical computer. Next, a relevant augmented Lagrangian for the target formulation can be generated on the classical computer to construct an update formula based on alternating direction method of multipliers (ADMM). ADMM is an algorithm that can solve complex optimization problems by breaking such problems into smaller pieces, wherein each piece of a problem can be easier to solve as compared to the problem as a whole. Finally, an effective method for selecting initial values for a classical-quantum hybrid algorithm can be implemented. The classical-quantum hybrid algorithm or quantum-classical hybrid algorithm can be employed iteratively to generate a solution to a target problem. It is to be appreciated that the terms ‘quantum-classical hybrid algorithm’ and ‘classical-quantum hybrid algorithm’ are used interchangeably throughout this specification.

The classical-quantum hybrid algorithm can include three updates, wherein the first update (update 1) and the third update (update 3) can be efficiently performed on the classical computer, and the second update (update 2) can be performed on a quantum computer. Update 1 can be solved on the classical computer using classical algorithms known in the art. During update 1, continuous variables of the augmented Lagrangian can be updated while fixing the binary variables of the augmented Lagrangian. Update 2 can be difficult to solve classically and therefore, update 2 be solved on the quantum computer using various types of quantum solvers such as a variational quantum eigensolver (VQE), a Quantum Approximate Optimization Algorithm (QAOA), a Gauss-Newton based quantum algorithm (GNQA), and so on. During update 2, binary variables of the augmented Lagrangian can be updated while fixing the continuous variables of the augmented Lagrangian. During update 3, a value for a Lagrange multiplier of the augmented Lagrangian can be identified. In some embodiments, an order of the updates can be swapped. A single iteration of the classical-quantum hybrid algorithm can include performing the three updates once, after which, stopping criteria can be checked to determine if the stopping criteria are met. If so, the iterations can be stopped. Otherwise, the iterations can continue. The techniques disclosed in the various embodiments herein were used to obtain benchmark results for several real-world problems, including a Knapsack problem, a multiple Knapsack problem, a job-shop scheduling problem, a travel salesman problem, arbitrage opportunity optimization problem, structure learning of a Bayesian network, etc. Each of these problems and the corresponding results are discussed in greater detail infra with reference to the figures.

Embodiments of the preset disclosure can provide flexibility in terms of the objective function of a problem formulation. For example, the classical-quantum hybrid algorithm can handle both, quadratic formulations, and more complex, higher-order formulation. The framework discussed herein can work with any gate-based quantum optimizer as a quantum-classical hybrid system and use a variety of adaptable gate-based methods. In contrast to some existing techniques, the method disclosed herein can present a formulation for a target problem wherein continuous variables can be introduced to convert inequality constraints into equality constraints. Another difference between existing techniques and the embodiments of the present disclosure can be in terms of the formulation to which the augmented Lagrange scheme can be applied, which can generate different corresponding updates based on the ADMM and convergence performance. As such, during each iteration of the ADMM, the method disclosed herein can offer better convergence rates of the ADMM as compared to some existing methods. Moreover, the method disclosed herein can be highly compatible with advanced warm-starting algorithms (e.g., warm-starting QAOA). As discussed above, the various embodiments disclosed herein can formulate an augmented Lagrangian for an ADMM suitable for quantum algorithms. As such, the various embodiments herein can propose an augmented Lagrangian method that can work effectively with established relaxation strategies. Moreover, for a smoother start in optimization, the various embodiments herein can begin with a relaxed solution from the primary problem, which can refine an initial estimate for the classical-quantum hybrid algorithm using known techniques such as cuts or lifting methods.

In various embodiments, a formulation for an MIP problem can be used to generate the augmented Lagrangian that can be solved on a hybrid classical-quantum system in combination with an alternating direction update rule. The alternating direction update rule can allow binary variables and continuous variables of the augmented Lagrangian to be updated separately, thereby separating the MIP problem into a continuous optimization problem that can be efficiently solved on a classical computer and a binary optimization problem that can be efficiently solved on a quantum computer. This can prevent the need for additional binary variables for solving the binary optimization problem, wherein such additional binary variables can increase the number of qubits needed to solve the target problem. Further, a selection of initial values for the binary variables and the continuous variables as a starting point for the computations can reduce the number of cycles needed for converging to an optimal solution to the target problem. Thus, the formulation of the MIP problem can reduce the amount of computation needed to solve a target problem by performing respective operations on systems (e.g., classical or quantum systems) that can most efficiently solve a particular operation. Doing so can enable hybrid classical-quantum systems to optimize MIP problems.

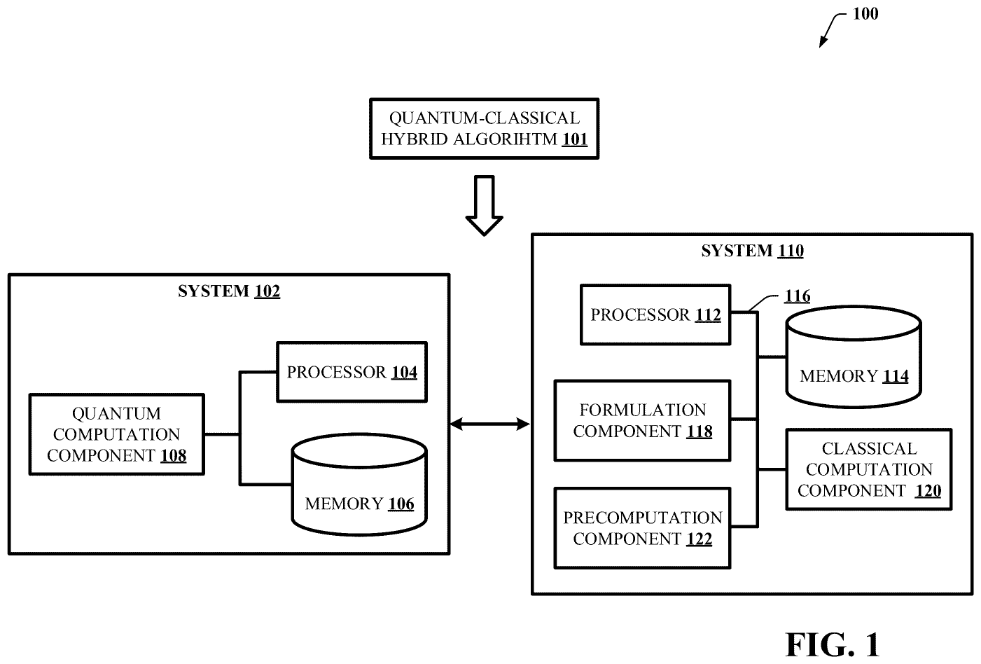

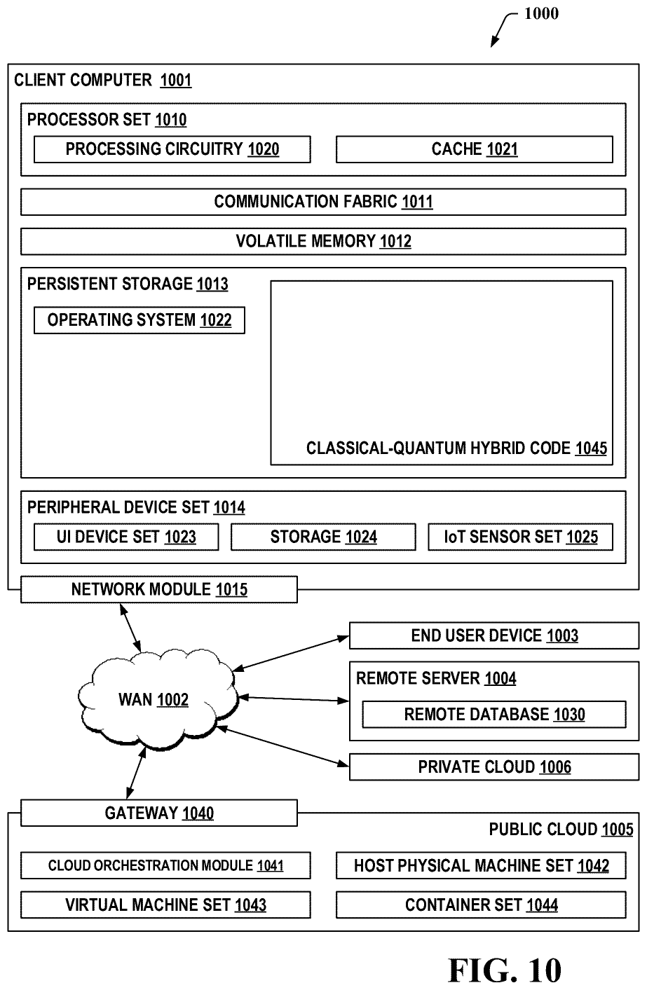

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1000 illustrated at FIG. 10. For example, system 100 can be associated with, such as accessible via, a computing environment 1000 described below with reference to FIG. 10, such that aspects of processing can be distributed between system 100 and the computing environment 1000. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can employ a classical-quantum hybrid algorithm for solving higher-order MIP problems in accordance with one or more embodiments described herein.

The system 100 and/or the components of system 100 can be employed to use hardware and/or software to solve problems that are highly technical in nature (e.g., related to quantum computing, higher-order MIP problems, etc.), that are not abstract and that cannot be performed as a set of mental acts by a human. Further, some of the processes performed may be performed by specialized computers for carrying out defined tasks related to solving higher-order MIP problems using a classical-quantum hybrid algorithm. The system 100 and/or components of the system can be employed to solve new problems that arise through advancements in technologies mentioned above, computer architecture, and/or the like. The system 100 can provide technical improvements to quantum computing systems by improving efficiency of quantum computations, reducing resource utilization during a quantum computing process, etc. For example, embodiments disclosed herein can solve a higher-order MIP problem directly, without needing to deduct the higher-order MIP problem to a quadratic binary problem with efficient resource utilization in terms of the number of qubits and/or other quantum computing resources. Specifically, the various embodiments disclosed herein can formulate an augmented Lagrangian for an ADMM suitable for quantum algorithms. Further, embodiments disclosed herein can separate the higher-order MIP problem into a continuous optimization problem and a binary optimization problem. An advantage of the augmented Lagrangian framework can be that only as many qubits as the number of binary variables present in the original problem can be needed to solve the binary optimization problem, which can promote efficient utilization of resources during the quantum computation process and increase efficiency of quantum computations, for example, on gate-based quantum computers. Thus, various embodiments herein can prevent a size of the binary optimization problem from increasing due to higher-order terms and constraints and can handle problems that include continuous variables.

Additionally, with respect to an optimal solution for a QUBO, the smaller the gap between the best solution and the next best solution, the more difficult reaching an optimal solution can be. In the quantum context, it is known that the smaller the gap between the energy value of the ground state of the relevant Hamiltonian and that of the first excited state, the higher the cost of reaching an optimal solution can be. Considering the case of a constrained pure binary problem, the eigenvalue gap of the Hamiltonian converted from QUBO using slack variables tends to be much smaller than the eigenvalue gap of the Hamiltonian to be solved in a formulation generated by embodiments disclosed herein.

Discussion turns briefly to processor 104 and memory 106 of system 102, wherein system 102 can be a quantum computer. For example, in one or more embodiments, system 102 can comprise processor 104 (e.g., a quantum processing unit (QPU)). In one or more embodiments, a component associated with system 102, as described herein with or without reference to the one or more figures of the one or more embodiments, can comprise one or more computer and/or machine readable, writable and/or executable components and/or instructions that can be executed by processor 104 to enable performance of one or more processes defined by such component(s) and/or instruction(s). In one or more embodiments, system 102 can comprise a computer-readable memory (e.g., memory 106) that can be operably connected to processor 104. Memory 106 can store computer-executable instructions that, upon execution by processor 104, can cause processor 104 and/or one or more other components of system 102 (e.g., quantum computation component 108) to perform one or more actions. In one or more embodiments, memory 106 can store the computer-executable components (e.g., quantum computation component 108).

Discussion turns next to processor 112, memory 114 and bus 116 of system 110, wherein system 110 can be a classical computer operably connected to system 102. For example, in one or more embodiments, the system 110 can comprise processor 112 (e.g., computer processing unit, microprocessor, classical processor, and/or like processor). In one or more embodiments, a component associated with system 110, as described herein with or without reference to the one or more figures of the one or more embodiments, can comprise one or more computer and/or machine readable, writable and/or executable components and/or instructions that can be executed by processor 112 to enable performance of one or more processes defined by such component(s) and/or instruction(s). In one or more embodiments, system 110 can comprise a computer-readable memory (e.g., memory 114) that can be operably connected to the processor 112. Memory 114 can store computer-executable instructions that, upon execution by processor 112, can cause processor 112 and/or one or more other components of system 110 (e.g., formulation component 118, classical computation component 120, and/or precomputation component 122) to perform one or more actions. In one or more embodiments, memory 114 can store computer-executable components (e.g., formulation component 118, classical computation component 120, and/or precomputation component 122).

System 110 and/or a component thereof as described herein, can be communicatively, electrically, operatively, optically and/or otherwise coupled to one another via bus 116. Bus 116 can comprise one or more of a memory bus, memory controller, peripheral bus, external bus, local bus, and/or another type of bus that can employ one or more bus architectures. One or more of these examples of bus 116 can be employed. In one or more embodiments, system 110 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 110 can reside in the cloud, and/or can reside locally in a local computing environment (e.g., at a specified location(s)).

System 100 can comprise one or more computer and/or machine readable, writable and/or executable components and/or instructions that, when executed by processor 104 and/or processor 112, can enable performance of one or more operations defined by such component(s) and/or instruction(s). For example, in various embodiments, formulation component 118 can formulate a higher-order MIP problem for applying an augmented Lagrange scheme. Stated differently, formulation component 118 can generate a new formulation for a higher-order MIP problem for applying an augmented Lagrange scheme. Formulating the higher-order MIP can involve reformulation of an original formulation (e.g., target problem formulation) of the target problem to a new formulation (e.g., second formulation) to which the quantum-classical hybrid algorithm can be applied. For example, system 110 can receive from a user, a target problem expressed as a higher-order MIP problem, as given by equation 1. The target problem can be a real-world problem such as a knapsack problem, multiple knapsack problems, a job-shop scheduling problem, a travel salesman problem, an arbitrage opportunity optimization problem, structure learning of a Bayesian network, and so on. A higher-order problem can indicate a problem formulated as a higher-order polynomial (e.g., x²+x³+x^{N}, wherein N can be a positive integer), and MIP can indicate that some variables in the problem formulation can be binary and other variables can be real-valued. For example, in Equation 1, x can represent binary variables, and y can represent continuous or real-valued variables. Thus, Equation 1 can represent an exemplary target problem expressed as a higher-order MIP problem. As such, Equation 1 can be subject to the constraint A₁x+A₂y≤b.

$${min}_{\begin{matrix}x ∈ {\{ 0 , 1 \}}^{N} \\ y ∈ {ℝ}^{M}\end{matrix}} P ( x , y ) = {\sum }_{i , j} {c}_{ij} {x}^{i} {y}^{j} \\ subject to {A}_{1} x + {A}_{2} y \leq b \qquad Equation 1$$

Formulation component 118 can generate the new formulation for the higher-order MIP problem by introducing additional continuous variables, z∈ [symbol] ^{K}, into the target problem represented by Equation 1. The new formulation generated by formulation component 118 can be given by Equation 2, and the new formulation can allow an augmented Lagrangian approach to be used for solving the new formulation and generating a solution to the target problem. The augmented Lagrangian method can represent a class of algorithms for solving a constrained optimization problem by replacing the constrained optimization problem with a series of unconstrained optimization problems and adding a penalty term to an objective, designed to mimic a Lagrange multiplier. Introducing the additional continuous variables, z, can convert the inequality of the constraint for Equation 1 to an equality, as given by the constraint, A₁x+A₂y+z=b, for Equation 2. In Equations 1 and 2, x can represent binary variables, y can represent continuous or real-valued variables, c can represent a coefficient for a term (e.g., c=2 in the term 2x²), i and j can represent higher orders in the summation, N can be the number of binary variables, and M can be the number of continuous variables, wherein M can be a fixed number depending on the target problem. Further, in the constraints for Equations 1 and 2, A₁ can be the matrix (K×M) for linear constraints, A₂ can be the matrix (K×M) for linear constraints, b can be a K dimensional vector for linear constraints, and K can be the number of constraints. In Equation 2, K can be the number of additional variables, z, that can be introduced by formulation component 118 into the target problem. It is to be appreciated that Equations 1 and 2 can be different for different target problems.

$${min}_{\begin{matrix}x ∈ {\{ 0 , 1 \}}^{N} \\ v = ( y , z ) ∈ {ℝ}^{M} ⊕ {ℝ}^{K}\end{matrix}} P ( x , y ) = {\sum }_{i , j} {c}_{ij} {x}^{i} {y}^{j} subject to {A}_{1} x + {A}_{2} y + z = b \qquad Equation 2$$

As discussed above, formulation component 118 can generate the new formulation for the higher-order MIP problem for applying an augmented Lagrange scheme. For example, upon generation of the new formulation, formulation component 118 can apply an augmented Lagrange scheme to generate another formulation (e.g., third formulation),

$${min}_{x , v , λ} L ( x , v , λ ) ,$$

wherein L(x, v, λ) represents the augmented Lagrangian given by Equation 3. In Equation 3, x represents the binary variables, v represents the continuous variables, and λ is a Lagrange multiplier. Further, A₃ represents the coefficient of v, and v is defined as v=y+z.

$$L ( x , v , λ ) = P ( x , y ) + λ ( b - {A}_{1} x - {A}_{2} y - z ) + \frac{ρ}{2} {‖ b - {A}_{1} x - {A}_{2} y - z ‖}^{2} = P ( x , y ) + λ ( b - {A}_{1} x - {A}_{3} v ) + \frac{ρ}{2} {‖ b - {A}_{1} x - {A}_{3} v ‖}^{2} \qquad Equation 3$$

Equation 3 can be solved by employing quantum-classical hybrid algorithm 101 using a classical computer and quantum computer. For example, in various embodiments, classical computation component 120 can employ quantum-classical hybrid algorithm 101 to update one or more continuous variables in the higher-order MIP problem using classical optimization, and quantum computation component 108 can employ quantum-classical hybrid algorithm 101 to update one or more binary variables in the higher-order MIP problem using quantum optimization. Classical computation component 120 can update the one or more continuous variables on a classical system (e.g., system 110) by fixing the one or more binary variables, and quantum computation component 108 can update the one or more binary variables on a quantum system (e.g., system 102) by fixing the one or more continuous variables.

More specifically, solving Equation 3 can involve minimizing the augmented Lagrangian. In this regard, Equation 2 can be an equivalent formulation to the target problem and Equation 2 can also be equivalent to the minimization of the augmented Lagrangian (i.e.,

$${min}_{x , v , λ} L ( x , v , λ ) ) .$$

The minimization of the augmented Lagrangian can be performed on the quantum computer in combination with an alternating direction update rule or ADMM. In other words, the problem of minimizing the augmented Lagrangian given by Equation 3 can be solved on the quantum computer in combination with an alternating direction update rule or ADMM. The alternating direction update rule or ADMM is a standard approach that can allow separating the updating of variables. ADMM is an algorithm that can solve complex optimization problems by breaking such problems into smaller pieces, wherein each piece of a problem can be easier to solve as compared to the problem as a whole. For example, an algorithm of the alternating direction update rule can allow the variables x, y, and z to be updated separately. For example, the main algorithm for quantum-classical hybrid algorithm 101 can include three steps which are described in greater detail infra. The first step of quantum-classical hybrid algorithm 101 can include updating (e.g., by classical computation component 120) only the continuous variables on the classical computer by applying the alternating direction update rule. The second step of quantum-classical hybrid algorithm 101 can include updating (e.g., quantum computation component 180) only the binary variables on the quantum computer. The third step of quantum-classical hybrid algorithm 101 can include computations performed (e.g., by classical computation component 120) on the classical computer to update the value of the Lagrange multiplier. The three updates can be part of minimizing the augmented Lagrangian of Equation 3. It is to be appreciated that in some scenarios, the augmented Lagrangian can also be maximized. For example, Equation 1 can be

$${min}_{\begin{matrix}x ∈ {\{ 0 , 1 \}}^{N} \\ y ∈ {ℝ}^{M}\end{matrix}} - P ( x , y ) = {\sum }_{i , j} {c}_{ij} {x}^{i} {y}^{j}$$

for a different target problem, wherein a solution to the target problem can be generated by employing system 100 to maximize the corresponding augmented Lagrangian.

The first step or first update of quantum-classical hybrid algorithm 101 can be described by Equation 4, the second step or second update of quantum-classical hybrid algorithm 101 can be described by Equation 5, and the third step or third update of quantum-classical hybrid algorithm 101 can be described by Equation 6.

$$Update 1 : {v}_{k + 1} = {arg}_{v ∈ {ℝ}^{M + K}} min L ( {x}_{k} , v , {λ}_{k} ) \qquad Equation 4$$

$$Update 2 : {x}_{k + 1} = {arg}_{x ∈ {\{ 0 , 1 \}}^{N}} min L ( x , {v}_{k + 1} , {λ}_{k} ) \qquad Equation 5$$

$$Update 3 : {λ}_{k + 1} = {λ}_{k} + ρ ( b - {A}_{1} {x}_{k + 1} - {A}_{3} {v}_{k + 1} ) \qquad Equation 6$$

As stated elsewhere herein, classical computation component 120 can update the continuous variables on the classical computer by applying update 1 to the augmented Lagrangian from Equation 3. Update 1 can be a continuous problem (i.e., involving continuous variables) and in most cases of interest, update 1 can represent a convex quadratic problem (QP) that can be efficiently solved on the classical computer. Thereafter, quantum computation component 108 can update the binary variables on the quantum computer by applying update 2 to the augmented Lagrangian from Equation 3. Updating the binary variables can involve solving the right-hand side of the equality in Equation 5, which can be efficiently performed by the quantum computer (e.g., by quantum computation component 108). Update 2 can represent a HUBO of size N that can be solved on the quantum computer by applying quantum solvers such as VQE, QAOA, GNQA, etc. After execution of update 2, update 3 can be performed on the classical computer. Updates 1, 2 and 3 can be sequential updates such that updated variables from update 1 can be used in update 2. For example, the updated value of vₖ₊₁ from update 1 can be used (e.g., by quantum computation component 108) as the value for vₖ₊₁ when solving the right-hand side of the equality in Equation 5. Thus, quantum-classical hybrid algorithm 101 can be efficiently applied on a hybrid system of quantum computers and classical computers, such as system 100.

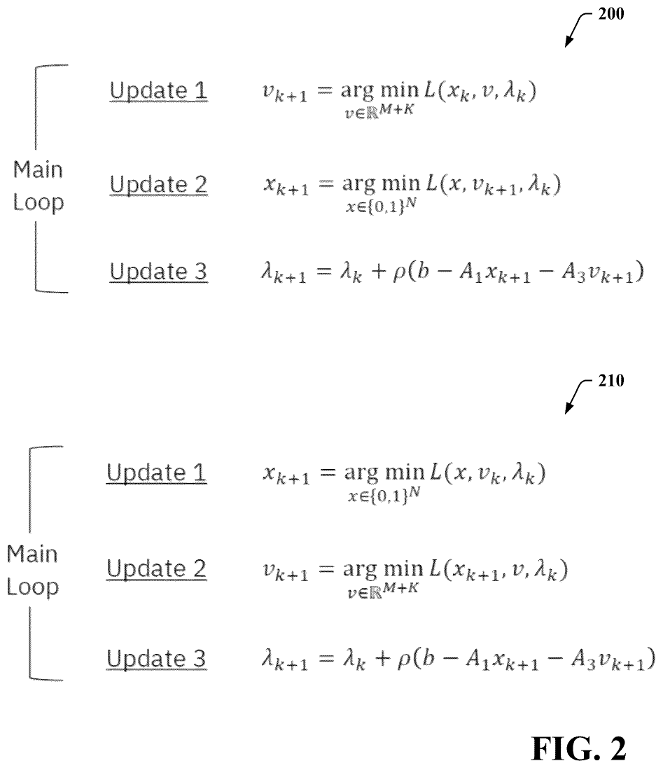

In some embodiments, the continuous variables can be changed on the classical side/classical computer for update 1. In other embodiments, an order of the updates of quantum-classical hybrid algorithm 101 can be changed. Two types of update orders can be possible for quantum-classical hybrid algorithm 101, which are described in greater detail infra with reference to FIG. 2. Update 1, update 2 and update 3 can form one loop of quantum-classical hybrid algorithm 101. In other words, the main loop of quantum-classical hybrid algorithm 101 can represent the set of updates 1, 2 and 3, and the main loop can be repeated until some stopping criteria can be satisfied. After each execution of the main loop, the stopping criteria can be checked (e.g., by classical computation component 120) and if a solution generated by the execution meets the stopping criteria, the iterations can be stopped and the final results can be output (e.g., at a user interface (UI)). The final results can be values of the variables, x and y, as solutions to the target problem. The stopping criteria can be dependent on the target problem or the users. For example, in some situations, a stopping criterion can be a number of iterations, and in other situations, the stopping criterion can be a particular result.

In various embodiments, initial values can be guessed for the binary variables and the continuous variables as a starting point for quantum-classical hybrid algorithm 101 to solve the higher-order MIP (e.g., the formulation of Equation 2) and approximate a solution for the corresponding target problem. The initial values can be generated and selected (e.g., by precomputation component 122) as part of a precomputation step on the classical computer (e.g., system 110), for example, before the three sequential updates of quantum-classical hybrid algorithm 101 including the quantum computations can be initiated. In general, the initial guess can affect the efficiency of a process of approximating the solution to the target problem, wherein a good initial guess can result in a more efficient process for approximating the solution to the target problem.

In some embodiments, precomputation component 122 can select a solution of a relaxation problem as the initial value that can be used by quantum-classical hybrid algorithm 101 to solve the higher-order MIP problem. For example, precomputation component 122 can solve a relaxation problem to generate the initial value, wherein solving the relaxation problem can involve solving the second formulation of the higher-order MIP problem (e.g., the formulation of Equation 2) on the classical computer (e.g., system 110) to set all the binary variables in the second formulation to continuous variables. That is, in the exemplary scenario considered herein, precomputation component 122 can solve Equation 2 by considering x as a continuous variable. Solving relaxation problems can be a standard approach to generate a good approximation of a solution for the target problem. For example, solving a relaxation problem to generate the initial value can allow quantum-classical hybrid algorithm 101 to being with a good initial guess, that is, an initial guess that can allow the quantum computer to solve a problem with fewer steps.

In other embodiments, precomputation component 122 can select a result generated by applying a computationally cheap cut or lifting to a relaxed problem as the initial value that can be used by quantum-classical hybrid algorithm 101 to solve the higher-order MIP problem. For example, some classical approaches can be adopted to generate a better initial guess and a more efficient optimization process. For example, precomputation component 122 can apply computationally cheap cuts (e.g., a Gomory cut, a Knapsack cover, etc.) or lifting techniques to relaxed problems to generate the initial guess. Taking the initial value as the solution of a relaxation problem can be the most general approach, and depending on the problem, applying cuts or lifting can sometimes generate better and more accurate initial approximations that can lead to more efficient optimizations. While the approach described herein can be heuristic (e.g., as opposed to a mathematical guarantee for attaining an optimal solution), the choice of initial values for the iterative method of using quantum-classical hybrid algorithm 101 can have a significant impact in increasing a probability of obtaining an optimal solution or a good approximation to the target problem. That is, although the method disclosed herein can be heuristic, the method can leverage quantum computing capabilities that can have the potential to provide a quantum advantage.

In various embodiments, employing quantum-classical hybrid algorithm 101 can separate the higher-order MIP problem into a continuous optimization problem and a binary optimization problem. In various embodiments, a size of the binary optimization problem can remain equal to a number of one or more binary variables in the higher-order MIP problem. In various embodiments, the binary optimization problem can be solved using quantum algorithms and without introducing auxiliary binary variables. The formulation in Equation 7 can be used to further explain this concept, even though Equation 7 can represent an MIP problem that is not a higher-order problem. Equation 7 can be a formulation for a knapsack problem. The standard or common approach (e.g., without implementing embodiments of the present disclosure) for solving the knapsack problem can involve converting the constraint a·x≤b into the objective c·x by introducing some select variables. For example, the standard approach can involve addition of extra qubits to generate the equation a·x+x′=b, wherein x and x′ represent binary variables, and the constraint can be converted into a formulation that is usually, ∥b−(a·x+x′)∥². Thus, in the standard approach the inequality can be converted into the objective function by introducing additional binary variables that can increase the number of qubits needed to solve the target problem on a quantum computer. On the contrary, the various embodiments discussed herein can implement the alternative direction update method (i.e., alternative direction update rule or ADMM), which can prevent the need for additional binary variables and extra qubits.

$${minimize}_{x ∈ {\{ 0 , 1 \}}^{N}} c \cdot x \\ subject to a \cdot x \leq b \qquad Equation 7$$

In summary, various embodiments herein can address higher-order MIP problems using quantum computers and a classical-quantum hybrid algorithm. The various embodiments herein can solve higher-order MIP combinatorial problems with constraints. As stated elsewhere herein, problems that can be solved using embodiments of the present disclosure can include knapsack problems that are basic combinatorial problems, job scheduling problems, and various other practical problems that can be formulated as MIP problems or higher-order MIP problems. The optimization framework described above, including the formulation of the higher-order MIP problem, execution of the classical-quantum hybrid algorithm (or quantum-classical hybrid algorithm 101) and choice of initial values for the classical-quantum hybrid algorithm, can separate problems into continuous optimization problems and binary optimization problems, wherein each type of problem can be solved by a different solver, iteratively. This can allow a system (e.g., system 100) to handle MIPs. The optimization framework can further allow a size of a binary optimization problem to be solved to remain the same as the original number of binary variables, which can prevent the introduction of auxiliary variables to handle constraints. Further, using quantum algorithms, the optimization framework can solve a HUBO directly, which can prevent the introduction of auxiliary binary variables in the computations to reduce higher-order terms to quadratic terms, wherein the number of such auxiliary variables can grow exponentially.

FIG. 2 illustrates diagrams of example, non-limiting loops 200 and 210 of updates comprised in the classical-quantum hybrid algorithm for solving higher-order MIP problems in accordance with one or more embodiments described herein. One or more operations described with reference to FIG. 2 can be performed by one or more components of FIG. 1. Repetitive description of like elements and/or processes employed in respective embodiments is omitted for sake of brevity.

As discussed with reference to FIG. 1, an order of the updates of quantum-classical hybrid algorithm 101 can be changed, and two types of update orders can be employed for quantum-classical hybrid algorithm 101. Further, an initial value can be selected as a starting point for quantum-classical hybrid algorithm 101 to solve the higher-order MIP (e.g., the formulation of Equation 2) and approximate a solution for a corresponding target problem. FIG. 2 illustrates non-limiting loop 200 (loop 200) and non-limiting loop 210 (loop 210). Loop 200 represents the main loop (algorithm 1 or update rule 1) of quantum-classical hybrid algorithm 101 including update 1, update 2, and update 3 as given by Equations 4, 5 and 6, and loop 200 represents a first type of update order/first order of the updates involved in quantum-classical hybrid algorithm 101. Loop 210 represents the main loop (algorithm 2 or update rule 2) of quantum-classical hybrid algorithm 101 including update 1, update 2, and update 3 as given by Equations 8, 9 and 10, and loop 210 represents a second type of update order/second order of the updates involved in quantum-classical hybrid algorithm 101. In some embodiments, loop 200 can be employed for solving a higher-order MIP problem, whereas in other embodiments, loop 210 can be employed for generating a solution to a higher-order MIP problem.

$$Update 1 : {x}_{k + 1} = {arg}_{x ∈ {\{ 0 , 1 \}}^{N}} min L ( x , {v}_{k} , {λ}_{k} ) \qquad Equation 8$$

$$Update 2 : {v}_{k + 1} = {arg}_{v ∈ {ℝ}^{M + K}} min L ( {x}_{k + 1} , v , {λ}_{k} ) \qquad Equation 9$$

$$Update 3 : {λ}_{k + 1} = {λ}_{k} + ρ ( b - {A}_{1} {x}_{k + 1} - {A}_{3} {v}_{k + 1} ) \qquad Equation 10$$

To effectively implement the initial value selection, loop 200 can be utilized. However, considering a different initial value than the one used in loop 200, loop 210 can be utilized, wherein loop 210 can swap an order of updating the binary variables (e.g., by quantum computation component 108) and updating the continuous variables (e.g., by classical computation component 120). As such, depending on a given scenario, either loop 200 or loop 210 can be employed to solve a higher-order MIP problem. As described with reference to FIG. 1, the initial value selection can include setting the initial value as the solution of a relaxation problem (typically, a solution generated (e.g., by precomputation component 122) wherein all variables can be solved as continuous variables) or, depending on a target problem, applying computationally cheap cuts (e.g., Gomory cut or Knapsack cover, etc.) or lifting (e.g., by precomputation component 122) to relaxed problems to find better initial values.

A workflow of quantum-classical hybrid algorithm 101 can be outlined by the pseudo code described as follows. An initialization or precomputation process for quantum-classical hybrid algorithm 101 can include the following steps. First, formulation component 118 can determine the continuous variables, z; to be added (the number of the continuous variables, z, being equal to the number of inequality constraints) for formulating the augmented Lagrangian, L, of Equation 3 and specify the range for each variable. For example, formulation component 118 can convert the constraint 2x₁+3x₂+x₃≤3 to 2x₁+3x₂+x₃+z₁=3, wherein 0≤z₁≤3, for a target problem. In another example, formulation component 118 can convert the constraint 3x₁+x₂+4x₃≤4 to 3x₁+x₂+4x₃+z₂=4, wherein 0≤z₂≤4, for a different target problem. Thereafter, precomputation component 122 can determine the coefficient A₃ of v in the augmented Lagrangian, L(x, v, λ), where v is defined as v=y+z.

Next, the variables to be used in the main loop of ADMM can be identified (e.g., by precomputation component 122), with the aim of the number of components equaling the number of constraint expressions. According to the relation in Equation 3, the variables can include binary variables, x, continuous variables, v, and a Lagrange multiplier, λ. As such, subsequent precomputation steps can be performed by precomputation component 122, including determining and fixing the value of the coefficient, ρ, for the penalty term in L, setting the initial value for the Lagrange multiplier, λ, denoted as λ₀, and establishing initial values for x and v with the aim to approximate the optimal solution to the target problem as accurately as possible. As described above, the initial values can be established using the following strategies. In an embodiment, a relaxation solution to the problem described by Equation 2 can be computed by precomputation component 122 using a classical computer (e.g., system 110). In another embodiment, depending on the problem type, methods to obtain more accurate relaxation solutions, such as Gomory cuts, Knapsack-cover, lifting, etc., can be applied by precomputation component 122, wherein such methods can be effectively utilized in classical MIP solvers.

Executing the main loop of quantum-classical hybrid algorithm 101 can comprise performing the three sequential updates given by equations 4, 5 and 6 according to ADMM. For update 1, classical computation component 120 can update the continuous variables, v, in the augmented Lagrangian using the classical computer (e.g., system 110). In many scenarios, the computations can be convex QP, and such computations can be speedily solved using classical methods known in the art. For update 2, quantum computation component 108 can update binary variables, x, in the augmented Lagrangian using the quantum computer (e.g., system 102) with classical-quantum hybrid techniques, including VQE and QAOA. When using QAOA, update 2 can involve computing (e.g., by quantum computation component 108) the relaxation solution, xᵣₑₗₐₓ, with an updated v followed by updating the binary variables, x, using a warm-starting QAOA with an initial xᵣₑₗₐₓ. For update 3, the Lagrange multiplier, λ, can be updated. Updating λ can involve only arithmetic operations that can be rapidly performed on the classical computer by classical computation component 120.

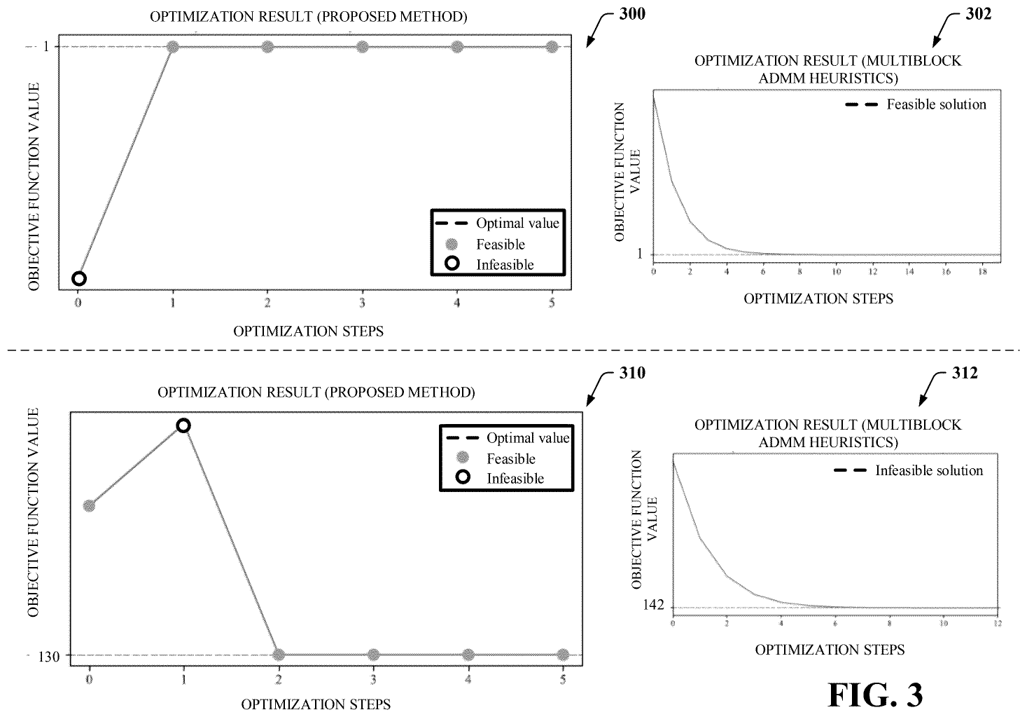

As discussed above, in some embodiments, the updates can be performed in a different order (e.g., loop 210), wherein the order of updating the binary variables and the continuous variables can be swapped. Upon updating of λ, user-defined stopping criteria (e.g., a maximum number of iterations) can be checked by precomputation component 122. If the stopping criteria are met and the maximum number of iterations have been reached, the iterations of the main loop can stop and the final results, x and y, can be output. Otherwise, the iterations can continue, and the main loop can begin again from update 1. FIGS. 3-8 illustrate exemplary results generated by the various embodiments herein for different real-world problems.

FIG. 3 illustrates example, non-limiting graphs 300 and 310 showing optimization results generated for target problems by employing the classical-quantum hybrid algorithm in accordance with one or more embodiments described herein. One or more operations described with reference to FIG. 3 can be performed by one or more components of FIG. 1. Repetitive description of like elements and/or processes employed in respective embodiments is omitted for sake of brevity.

Non-limiting graph 300 (graph 300) shows optimization results generated for a mixed-binary constrained optimization problem (MCBO) using the various embodiments disclosed herein. MCBOs can often appear in logistics, finance and operation research. In graph 300, the dotted horizontal line indicates the true value of the solution to the target problem, as also highlighted by the legend in graph 300. The true value can imply an exact answer or exact optimal solution to a problem. The legend in graph 300 also identifies feasible and infeasible points on the graph, wherein individual feasible and infeasible points can indicate solutions generated by quantum-classical hybrid algorithm 101 at each iteration. A solution can be considered feasible if the solution can satisfy the constraint for a target problem, and a solution can be considered infeasible if the solution cannot satisfy the constraint for the target problem. For example, with reference to Equation 2, an optimizer can attempt to find an optimal solution for the target problem, wherein the optimal solution can be a solution that can minimize the objective function, P(x, y)=Σ_{i,j}cᵢⱼxⁱy^{j}, while satisfying the constraint, A₁x+A₂y+z=b. In the process of reaching an optimal solution for a target problem, other solutions can be generated that do not satisfy the constraint. Such solutions can be known as infeasible solutions. In graph 300, the first point can represent an initial value used to approximate a solution to the target problem, and the initial value is illustrated in graph 300 as an infeasible solution, which can indicate that the initial value selection does not satisfy the constraint for the target problem but can be a good starting point for approximating the solution. As described elsewhere herein, the quantum-classical hybrid algorithm 101 can be iteratively implemented, wherein the updates of one iteration can generate a new initial value that can be used for another iteration. As evident from graph 300, quantum-classical hybrid algorithm 101 can reach the true value for a problem in a single step in certain scenarios and converge to the optimal solution faster, for example, as compared to some existing techniques that can reach the solution in multiple (e.g., 8 steps, 10, steps, etc.) steps as illustrated by graph 302.

Non-limiting graph 310 (e.g., graph 310) illustrates optimization results for a knapsack problem of size 5. Similar to graph 300, graph 310 shows a legend identifying the optimal solution, feasible points and infeasible points. Further, the first point in graph 310 can represent the initial value selected for the knapsack problem. As evident from graph 310, quantum-classical hybrid algorithm 101 can converge to the optimal solution in a few steps. On the contrary, certain other methods can generate infeasible solutions. For example, some existing solutions can generate different values and become stuck on the wrong value as the solution to the knapsack problem, as illustrated by graph 312. It is to be appreciated that the second point in graph 310 is an infeasible solution, because each step/iteration of quantum-classical hybrid algorithm 101 can involve sequential updates (e.g., updates 1, 2 and 3) as described in various embodiments, and during each update, the continuous and binary variables of the augmented Lagrangian can be updated. Considering an X-Y plane with the binary variables, x, on the horizontal axis (X-axis) and the continuous variables, y, on the vertical axis (Y-axis), the alternating direction update method can imply first updating, starting from an initial value, in the direction of y followed by updating in the direction of x. Thus, the movement towards the exact optimal solution can be a stepwise process and can involve traversing infeasible solutions along the path to the exact optimal solution. That is, in the intermediate process from the initial value to the exact optimal solution, the quantum-classical hybrid algorithm 101 can sometimes generate infeasible solutions.

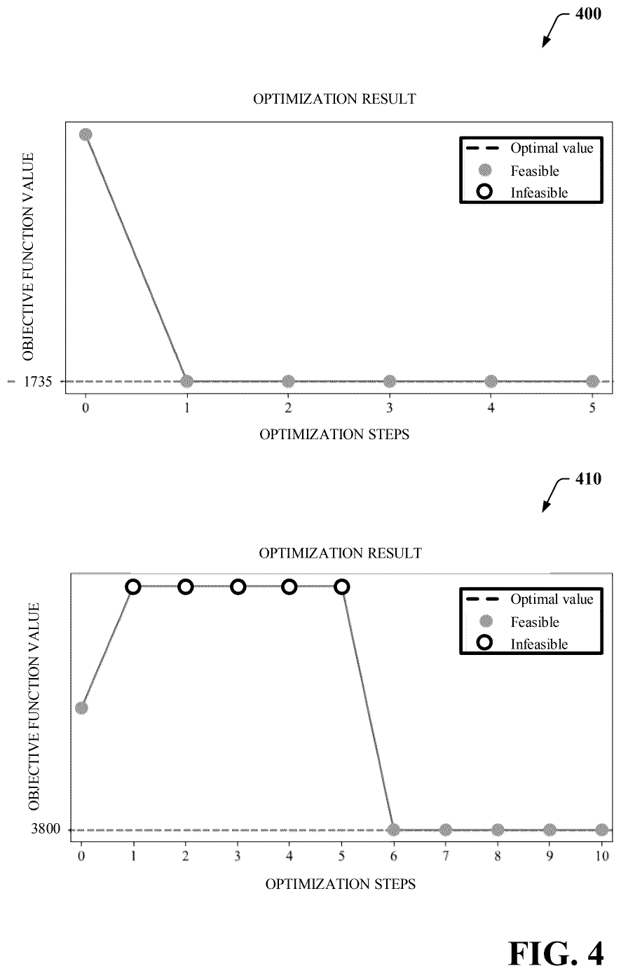

FIG. 4 illustrates example, non-limiting graphs 400 and 410 showing optimization results generated for a knapsack problem and multiple knapsack problems by employing the classical-quantum hybrid algorithm in accordance with one or more embodiments described herein. One or more operations described with reference to FIG. 4 can be performed by one or more components of FIG. 1. Repetitive description of like elements and/or processes employed in respective embodiments is omitted for sake of brevity.

With continued reference to at least FIGS. 1 and 2, FIG. 4 illustrates numerical results for knapsack problems generated by employing the various embodiments discussed herein. Non-limiting graph 400 (graph 400) illustrates optimization results for a Knapsack problem given by the formulation of Equation 7, for a test size N=7. It is to be appreciated that the formulation of Equation 7 can represent only an MIP problem and not a higher-order MIP problem due to absence of continuous variables, although the embodiments disclosed herein can be implemented to solve a higher-order MIP.

$${minimize}_{x ∈ {\{ 0 , 1 \}}^{N}} c \cdot x \\ subject to a \cdot x \leq b \qquad Equation 7$$

Generally, a knapsack problem can be a simple problem comprising a linear objective function, such as c·x, wherein c is always a positive number (i.e., c>0). For example, for a simple objective function given by 1(x₁)+2(x₂)+3(x₃), 1, 2 and 3 can be values of c. The goal of solving such a knapsack problem can be to minimize the objective function in terms of the three variables, x₁, x₂ and x₃, which can be binary variables, while identifying a combination of the binary variables that can satisfy a constraint, such as a·x≤b, wherein a and b also represent positive numbers. For example, the objective function 1(x₁)+2(x₂)+3(x₃) can be subject to the constraint 2(x₁)+3(x₂)+x₃≤5, and quantum-classical hybrid algorithm 101 can aim to find a combination of the binary variables x₁, x₂ and x₃ that can minimize the objective function, 1(x₁)+2(x₂)+3(x₃), while satisfying the constraint, 2(x₁)+3(x₂)+x₃≤5.

To solve the knapsack problem described above, a corresponding augmented Lagrangian can be formulated by formulation component 118, and the quantum-classical hybrid algorithm 101 can be applied to the augmented Lagrangian (e.g., by system 100). Quantum-classical hybrid algorithm 101 can be applied in either order (e.g., loop 200 or loop 210) for the knapsack problem. For example, in an embodiment, the quantum computer (e.g., system 102) can receive the augmented Lagrangian formulation and an initial value for implementing the quantum-classical hybrid algorithm 101. In graph 400, as well, the first point can represent the initial value that can be generated and selected by precomputation component 122 for quantum-classical hybrid algorithm 101 for solving the knapsack problem. As discussed earlier, the numerical results presented in graph 300 are based on a test size N=7, and the method discussed herein can solve QUBOs of size 7 at each optimization step, whereas the size of a QUBO converted from an MIP is 15. That is, quantum-classical hybrid algorithm 101 solved the knapsack problem by utilizing only 7 qubits, whereas other approaches can utilize 15 qubits. Thus, embodiments disclosed herein can promote efficient resource utilization of computational resources.

Non-limiting graph 410 (graph 410) illustrates optimization results generated by employing the various embodiments herein for a multiple knapsack problem given by the formulation of Equation 11, for a test size N=6. Like Equation 7, the formulation of Equation 11 can represent only an MIP problem and not a higher-order MIP problem due to absence of continuous variables.

$${minimize}_{x ∈ {\{ 0 , 1 \}}^{N}} c \cdot x \\ subject to Ax \leq b \qquad Equation 11$$

For the multiple knapsack problem, the method discussed herein can solve QUBOs of size 6 at each optimization step, whereas the size of a QUBO converted from an MIP is 62. That is, quantum-classical hybrid algorithm 101 solved the multiple Knapsack problem by utilizing only 6 qubits, whereas other approaches can utilize 62 qubits.

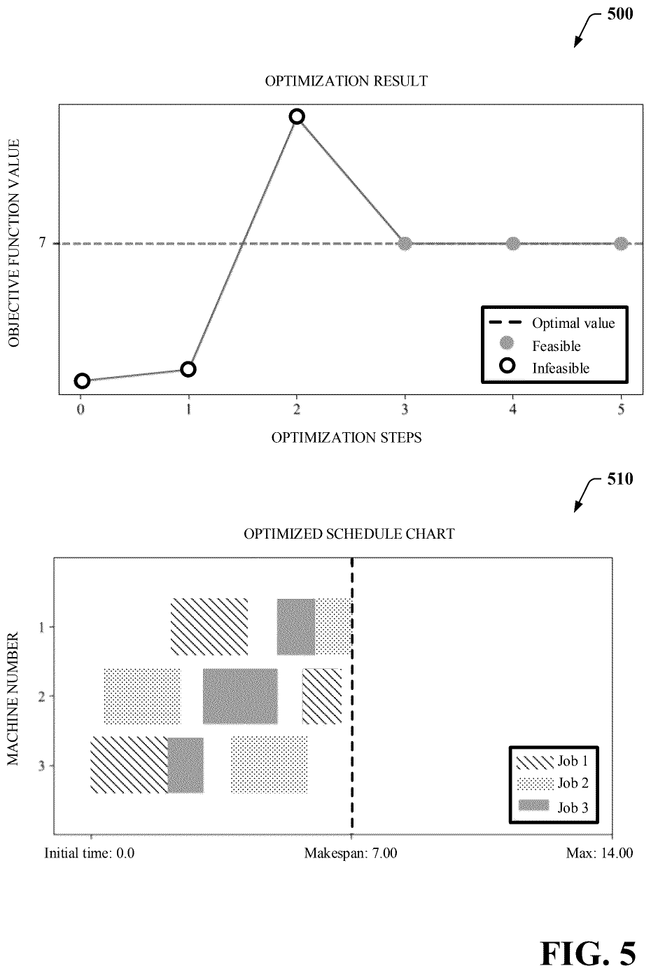

FIG. 5 illustrates example, non-limiting graphs 500 and 510 showing optimization results generated for a job-shop scheduling problem by employing the classical-quantum hybrid algorithm in accordance with one or more embodiments described herein. One or more operations described with reference to FIG. 5 can be performed by one or more components of FIG. 1. Repetitive description of like elements and/or processes employed in respective embodiments is omitted for sake of brevity.

With continued reference to at least FIGS. 1 and 2, FIG. 5 illustrates numerical results generated by employing the various embodiments discussed herein for a job-shop scheduling problem. Non-limiting graph 500 (graph 500) illustrates optimization results for a job-shop scheduling problem given by the formulation of Equation 12, for a test size N=9, M=10 and K=27. The formulation of Equation 12 can represent a higher-order MIP problem.

$${minimize}_{\begin{matrix}{x}_{ijk} ∈ \{ 0 , 1 \} \\ {y}_{ij ∈ ℝ} \\ c \geq 0\end{matrix}} C \\ subject to {y}_{{σ}_{h}^{j} j} \geq {y}_{{σ}_{h - 1}^{j} j} + {p}_{{σ}_{h - 1}^{j} j} \\ {y}_{ij} \geq {y}_{ik} + {p}_{ik} - {Vx}_{ijk} \\ {y}_{ik} \geq {y}_{ij} + {p}_{ij} - V ( 1 - {x}_{ijk} ) \\ C \geq {y}_{{σ}_{m}^{j} j} + {p}_{{σ}_{m}^{j} j} \\ {y}_{ij} \geq 0 \qquad Equation 12$$

The job-shop scheduling problem can involve optimizing the scheduling of three jobs on three machines based on some rules. Solving the job-shop scheduling problem can include scheduling the three jobs on the three machine such that the time taken by the three jobs to be completed can be minimized while satisfying the rules. For example, individual jobs cannot be set randomly, and need to be scheduled according to some rules needing some values to be optimized. The rules for scheduling the jobs can be described by the constraints given in Equation 12. For the job-shop scheduling problem considered herein, the target value or solution, C, can be the makespan which can be the total time for performing all the jobs on the machines. For example, the vertical dotted line in non-limiting graph 510 (graph 510) can represent the final time (e.g., in hours or minutes) when all jobs are completed, and machine number can indicate the specific machine for performing the three jobs or three types of jobs. Each machine can perform all three jobs. Graph 510 illustrates an optimized schedule chart corresponding to graph 500, showing the optimal solution to the job-shop scheduling problem.

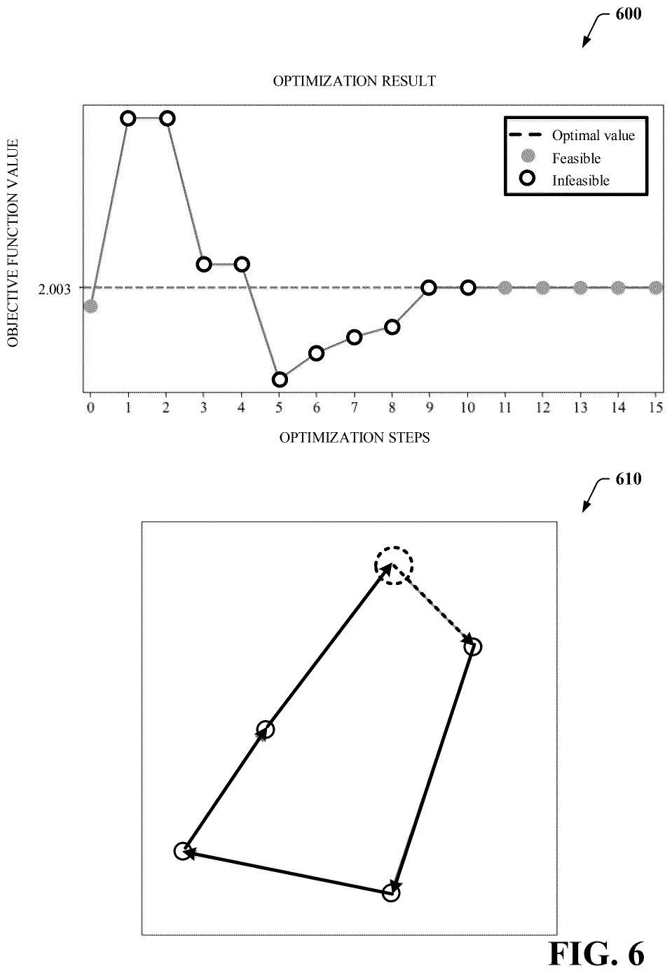

FIG. 6 illustrates example, non-limiting graphs 600 and 610 showing optimization results generated for a travel salesman problem by employing the classical-quantum hybrid algorithm in accordance with one or more embodiments described herein. One or more operations described with reference to FIG. 6 can be performed by one or more components of FIG. 1. Repetitive description of like elements and/or processes employed in respective embodiments is omitted for sake of brevity.

With continued reference to at least FIGS. 1 and 2, FIG. 6 illustrates numerical results for a travel salesman problem generated by employing the various embodiments discussed herein. Non-limiting graph 600 (graph 600) illustrates optimization results for a job-shop scheduling problem based on a Miller-Tucker-Zemlin formulation, for a test size N=13, M=4 and K=17. The Miller-Tucker-Zemlin formulation can represent a higher-order MIP problem and is a standard formulation for MIP for the travel salesman problem. The travel salesman problem can be a typical combinatorial problem. In some embodiments, other formulations can also be used. Travel salesman problems (or TSPs) can usually include routines or logistics related problems. The goal of solving the travel salesman problem can be to determine the minimum total distance from a departure point of a salesman, such that the salesman can visit each target city or target location only one time. That is, the salesman can commute from the departure point back to the departure point, visiting each target city along the way only one time. Non-limiting graph 610 (graph 610) can show results generated by employing quantum-classical hybrid algorithm 101 to solve the travel salesman problem. In graph 610, the dotted circle indicates the departure point of the salesman and the other circles indicate target cities. The arrows indicate the path that the salesman can travel, starting from the departure city to visit each target city only once before returning to the departure point. As indicated by the legend, the dotted line in graph 600 represents the exact optimal solution as the total distance of the path illustrated in graph 610.

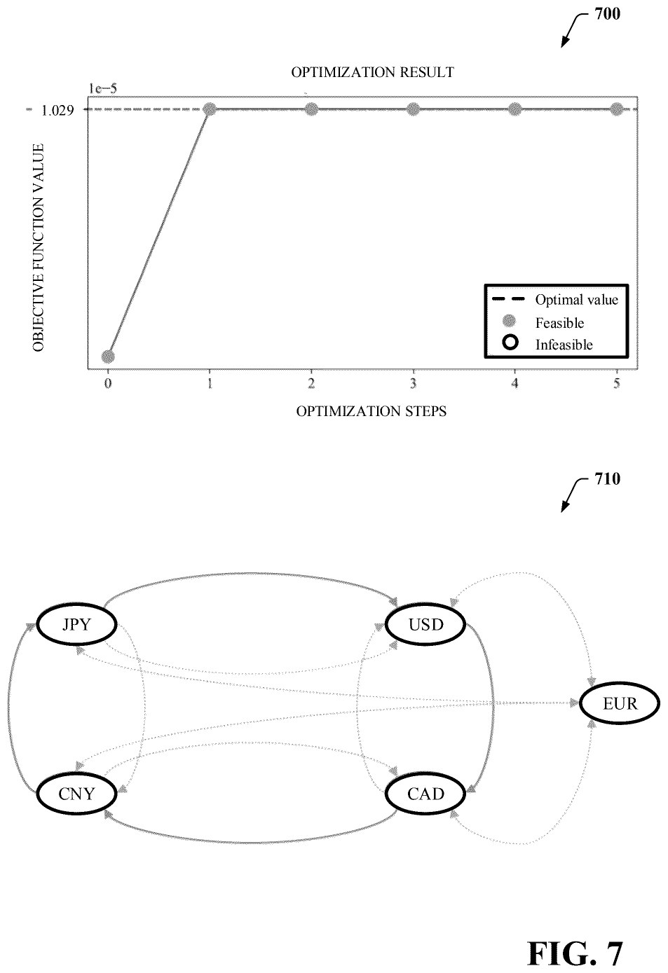

FIG. 7 illustrates example, non-limiting graphs 700 and 710 showing optimization results generated for an arbitrage opportunity optimization problem by employing the classical-quantum hybrid algorithm in accordance with one or more embodiments described herein. One or more operations described with reference to FIG. 7 can be performed by one or more components of FIG. 1. Repetitive description of like elements and/or processes employed in respective embodiments is omitted for sake of brevity.

With continued reference to at least FIGS. 1 and 2, FIG. 7 illustrates numerical results for an arbitrage opportunity optimization problem generated by employing the various embodiments discussed herein. Non-limiting graph 700 (graph 700) illustrates optimization results for an arbitrage opportunity optimization problem given by the formulation of Equation 13, for a test size N=16 and K=8. The formulation of Equation 13 can represent a node-based quadratic model.

$$maximize {\sum }_{i , j ∈ V} {\sum }_{k = 0}^{s} log {c}_{i j} {x}_{i , k} {x}_{j , k + 1} subject to {\sum }_{i = 1}^{{n}_{c}} {x}_{i , k} = 1 {x}_{i , k} {x}_{j , k + 1} = 0 \qquad Equation 13$$

Solving the arbitrage opportunity optimization problem can involve looping around different currencies to gain benefits by exchanges between currencies. The constraints for the arbitrage opportunity optimization problem can specify, for example, that the exchange route should be a cycle and the currency exchange should not stop at different points. Non-limiting graph 710 (graph 710) shows an optimized path corresponding to graph 700 for looping around different currencies. For example, the loop can begin from United States dollar (USD) and the exact optimal solution can suggest that the first currency exchange should be from USD to Canadian dollar (CAD) followed by an exchange to Yuan (CNY), yen (JPY), and back to USD. The dotted line in graph 700 indicates a value of the benefit of the exact optimal solution.

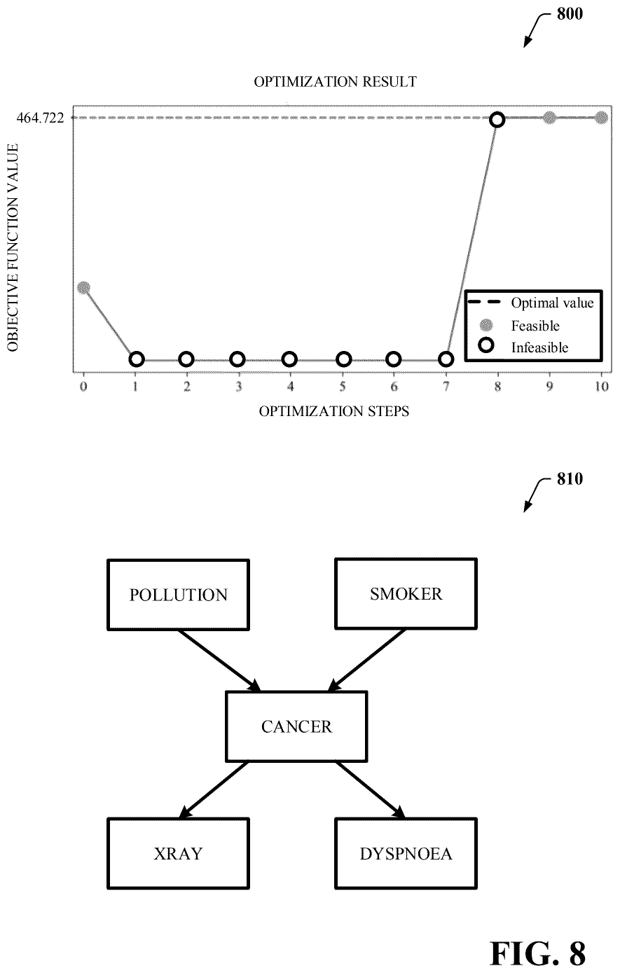

FIG. 8 illustrates an example, non-limiting graph 800 and an example, non-limiting chart 810 showing optimization results generated for structure learning of a Bayesian network by employing the classical-quantum hybrid algorithm in accordance with one or more embodiments described herein. One or more operations described with reference to FIG. 8 can be performed by one or more components of FIG. 1. Repetitive description of like elements and/or processes employed in respective embodiments is omitted for sake of brevity.

With continued reference to at least FIGS. 1 and 2, FIG. 8 illustrates numerical results generated by employing the various embodiments discussed herein. Non-limiting graph 800 (graph 800) illustrates optimization results in connection with structure learning of a Bayesian network (structure learning Bayesian problem), for a higher-order MIP problem formulation, for a test size N=20, M=5 and K=30. The problem herein can involve identifying relationships between different datasets, wherein such relationships can be initially unknown. The different blocks in non-limiting chart 810 (chart 810) represent five independent datasets containing information about the respective subjects (e.g., pollution, smoker, cancer, Xray, dyspnoea), and chart 810 can display relationships between the individual datasets, as determined by quantum-classical hybrid algorithm 101. A Bayesian network can reveal relationships between different datasets by using the Bayesian network structure. It was experimentally examined that the method disclosed by the various embodiments herein worked with the Bayesian Network Repository benchmarking set. Specifically, the method when applied to the cancer dataset, successfully reproduced the correct graph.

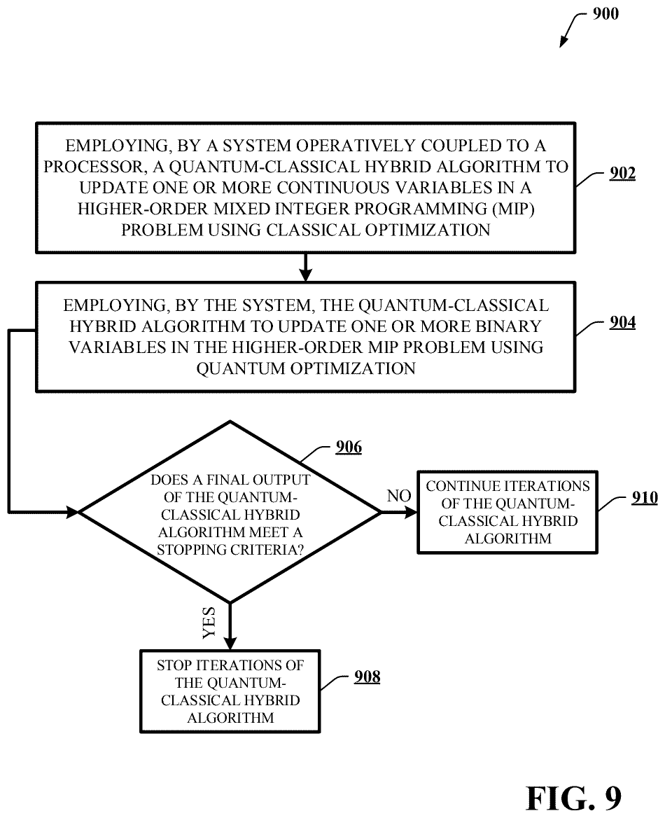

FIG. 9 illustrates a flow diagram of an example, non-limiting method 900 that can employ a classical-quantum hybrid algorithm for solving higher-order MIP problems in accordance with one or more embodiments described herein. One or more operations described with reference to FIG. 9 can be performed by one or more components of FIG. 1. Repetitive description of like elements and/or processes employed in respective embodiments is omitted for sake of brevity.

Non-limiting method 900 can be a method for utilizing quantum computing algorithms and an augmented Lagrangian scheme for iteratively solving a mixed variable problem (comprising binary variables and continuous variables) of higher-order MIP by using classical optimization on a classical system for determining updated continuous variables by fixing the binary variables, and using quantum optimization on a quantum system for determining updated binary variables by fixing the continuous variables.

At 902, the non-limiting method 900 can comprise employing (e.g., by classical computation component 120), by a system operatively coupled to a processor, a quantum-classical hybrid algorithm to update one or more continuous variables in a higher-order MIP problem using classical optimization.

At 904, the non-limiting method 900 can comprise employing (e.g., by quantum computation component 108), by the system, the quantum-classical hybrid algorithm to update one or more binary variables in the higher-order MIP problem using quantum optimization.

At 906, the non-limiting method 900 can comprise determining (e.g., by classical computation component 120), by the system, whether a final output of the quantum-classical hybrid algorithm meets a stopping criterion.

If yes, at 908, the non-limiting method 900 can comprise stopping, by the system, iterations of the quantum-classical hybrid algorithm.

If no, at 910, the non-limiting method 900 can comprise continuing, by the system, the iterations of the quantum-classical hybrid algorithm.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively update binary variables and continuous variables in an augmented Lagrangian by implementing a classical-quantum hybrid algorithm as the one or more embodiments described herein can enable this process. And, neither can the human mind nor a human with pen and paper solve a higher order MIP problem using the classical-quantum hybrid algorithm, as conducted by one or more embodiments described herein.

Embodiments of the present disclosure can provide a number of advantages, including improving efficiency of quantum computations and reducing resource utilization during a quantum computing process. For example, embodiments disclosed herein can solve a higher-order MIP problem directly and without needing to deduct the higher-order MIP problem to a quadratic binary problem with efficient resource utilization in terms of number of qubits and/or other quantum computing resources. Specifically, the various embodiments disclosed herein can formulate an augmented Lagrangian for an ADMM suitable for quantum algorithms. Further, embodiments disclosed herein can separate the higher-order MIP problem into a continuous optimization problem and a binary optimization problem. An advantage of the augmented Lagrangian framework can be that only as many qubits as the number of binary variables present in the original problem can be needed to solve the binary optimization problem, which can promote efficient utilization of resources during the quantum computation process and increase efficiency of quantum computations, for example, on gate-based quantum computers. Thus, various embodiments herein can prevent a size of the binary optimization problem from increasing due to higher-order terms and constraints and can handle problems that include continuous variables.

FIG. 10 illustrates a block diagram of an example, non-limiting operating environment 1000 in which one or more embodiments described herein can be facilitated. FIG. 10 and the following discussion are intended to provide a general description of a suitable operating environment 1000 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as classical-quantum hybrid code 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components; and
a processor that executes the computer-executable components stored in the memory, wherein the computer-executable components comprise:
a classical computation component that employs a quantum-classical hybrid algorithm to update one or more continuous variables in a higher-order mixed integer programming (MIP) problem using classical optimization; and
a quantum computation component that employs the quantum-classical hybrid algorithm to update one or more binary variables in the higher-order MIP problem using quantum optimization.

2. The system of claim 1, wherein the classical computation component updates the one or more continuous variables on a classical system by fixing the one or more binary variables.

3. The system of claim 1, wherein the quantum computation component updates the one or more binary variables on a quantum system by fixing the one or more continuous variables.

4. The system of claim 1, further comprising:
a formulation component that formulates the higher-order MIP problem for applying an augmented Lagrange scheme.

5. The system of claim 1, further comprising:
a precomputation component that selects a solution of a relaxation problem as an initial value used by the quantum-classical hybrid algorithm to solve the higher-order MIP problem.

6. The system of claim 5, wherein the precomputation component selects a result generated by applying a computationally cheap cut or lifting to a relaxed problem as the initial value.

7. The system of claim 1, wherein employing the quantum-classical hybrid algorithm separates the higher-order MIP problem into a continuous optimization problem and a binary optimization problem.

8. The system of claim 7, wherein a size of the binary optimization problem remains equal to a number of one or more binary variables in the higher-order MIP problem.

9. The system of claim 7, wherein the binary optimization problem is solved using quantum algorithms and without introducing auxiliary binary variables.

10. A computer-implemented method, comprising:
employing, by a system operatively coupled to a processor, a quantum-classical hybrid algorithm to update one or more continuous variables in a higher-order mixed integer programming (MIP) problem using classical optimization; and
employing, by the system, the quantum-classical hybrid algorithm to update one or more binary variables in the higher-order MIP problem using quantum optimization.

11. The computer-implemented method of claim 10, further comprising:
updating, by the system, the one or more continuous variables on a classical system by fixing the one or more binary variables.

12. The computer-implemented method of claim 10, further comprising:
updating, by the system, the one or more binary variables on a quantum system by fixing the one or more continuous variables.

13. The computer-implemented method of claim 10, further comprising:
formulating, by the system, the higher-order MIP problem for applying an augmented Lagrange scheme.

14. The computer-implemented method of claim 10, further comprising:
selecting, by the system, a solution of a relaxation problem as an initial value used by the quantum-classical hybrid algorithm to solve the higher-order MIP problem.

15. The computer-implemented method of claim 14, further comprising:
selecting, by the system, a result generated by applying a computationally cheap cut or lifting to a relaxed problem as the initial value.

16. The computer-implemented method of claim 10, wherein the employing separates the higher-order MIP problem into a continuous optimization problem and a binary optimization problem.

17. The computer-implemented method of claim 16, wherein a size of the binary optimization problem remains equal to a number of one or more binary variables in the higher-order MIP problem.

18. The computer-implemented method of claim 16, wherein the binary optimization problem is solved using quantum algorithms and without introducing auxiliary binary variables.

19. A computer program product for higher-order MIP problems, the computer program product comprising a computer readable storage medium having program instructions embodied therewith, the program instructions executable by a processor to cause the processor to:
employ, by the processor, a quantum-classical hybrid algorithm to update one or more continuous variables in a higher-order mixed integer programming (MIP) problem using classical optimization; and
employ, by the processor, the quantum-classical hybrid algorithm to update one or more binary variables in the higher-order MIP problem using quantum optimization.

20. The computer program product of claim 19, wherein the program instructions are further executable by the processor to cause the processor to:
update, by the processor, the one or more continuous variables on a classical system by fixing the one or more binary variables; and
update, by the processor, the one or more binary variables on a quantum system by fixing the one or more continuous variables.
